(19) United States
(12) Patent Application Publication
(10) Pub. No.: US 2007/0091809 A1
(43) Pub. Date: Apr. 26, 2007

(54) Managed network resource sharing and optimization method and apparatus

(76) Inventor: Jeffrey Christopher Smith, Atherton, CA (US)

Correspondence Address: PATENT DEPARTMENT;SKADDEN, ARPS, SLATE, MEAGHER & FLOM LLP, FOUR TIMES SQUARE, NEW YORK, NY, 10036, US

(21) Appl. No.: 11/395,032

(22) Filed: Mar. 31, 2006

Related U.S. Application Data
(63) Continuation-in-part of application No. 11/259,158, filed on Oct. 25, 2005.

(51) Int. Cl. G06F 15/173; H04J 1/16

(52) U.S. Cl. 370/235; 709/223

(57) ABSTRACT

A digital community provides shared resources across a wide collection of users. Users donate resources to the community and in return are allowed to employ resources of the community. The digital community conforms to a set of rules, or community rules, so as to enhance cooperation between users and increase resource reliability. The resource sharing rules allow for efficient allocation and utilization of community resources. The rules refer to the hardware, software, and donor behavior associated with each resource of the community.

### CROSS-REFERENCE TO RELATED APPLICATION

This application is a continuation-in-part of and claims priority from U.S. patent application Ser. No. 11/259,158, entitled “Managed Resources Sharing Method and Apparatus” filed Oct. 25, 2005, now pending, which is incorporated herein by reference.

### BACKGROUND

Increasingly, digital assets are stored on computing devices such as desktop computers, servers, phones, handheld devices, etc. The devices or ‘peers’ storing these digital assets are commonly connected to high performance networks. Typically, these peers do not efficiently allocate resources, including for example storage, bandwidth, content (both proprietary and non-proprietary), applications and programs, etc. For example, one peer with a library of music files (e.g., in digital format) risks losing that library if a disk fails or is destroyed. In another case, two peers may retain a proprietary content file, yet seldom require concurrent access to that content. In another case, the bandwidth of one peer may be reallocated to another peer during periods of peek bandwidth usage for the latter peer. Accordingly, there is a need to allow a set of peers to pool their resources in a trusted network, in order to more efficiently allocate those resources.

### BRIEF DESCRIPTION OF THE DRAWINGS

FIG. 1 illustrates a typical Trusted Peer Network;

FIG. 2 illustrates logical elements of a peer in a resource sharing community;

FIG. 3 illustrates logical elements of a governor node in the Trusted Peer Network FIG. 1;

FIG. 4 illustrates logical elements of an agent module associated with a peer in the configuration of FIG. 1;

FIG. 5 is a flow diagram illustrating peer initiation steps in the Trusted Peer Network of FIG. 1;

FIG. 6 is a flow diagram illustrating further details of the rule processing step of FIG. 5; and

FIG. 7 is a flow diagram illustrating the operation of an agent module on a peer when observing an event.

### SUMMARY OF THE INVENTION

When the set of peers are connected in a ‘Trusted Peer Network,’ the resources on the set of peers can be pooled in order to more efficiently allocate those resources. Hence, a Trusted Peer Network is a mechanism for peers on a network to authenticate and join together in order more efficiently to solve such common problems such as back-up storage, content distribution and sharing, bandwidth optimization, application sharing, etc. A Trusted Peer Network pools the combined resources of a network, reallocating the rights or use of a given resource based on a variety of factors, including demand, currency (e.g. a given peer's contribution of resources weighted by the behavior of that peer), and network usage characteristics.

Therefore, in accordance with the invention there is provided a method for facilitating a Trusted Peer Network which provides pooling resources across a wide collection of users, which, for example, allows users to exploit reliable longer term storage for their digital assets and more generally optimize the allocation of resources on that network. In one embodiment, the invention provides for the allocation and management of resources on the Trusted Peer Network. The system includes a plurality of peer computer systems, whereby each peer computer system includes computer system hardware, communication interface, applications, and data. The system maintains a profile of the resources each peer has ‘contributed’ to the Trusted Peer Network, which is generated by reference to at least attributes relating to the hardware, software, network resources and bandwidth, and content associated with each peer. The system also maintains a currency for each peer, whereby the system values the resources contributed by a peer based on the behavior of that peer over time. The system also maintains and analyzes peer usage information, for example what peers commonly access given files or data, utilized bandwidth, or require access to back-up data. The system enforces a set of rules, or community rules, governing resource allocation across the Trusted Peer Network to assist in the re-allocation of resources.

In another embodiment, the invention provides a data storage system for increasing the reliability of data stored on a peer system. The system includes a plurality of peer computer systems, whereby each peer computer system including computer system hardware, communication interface, applications, and data. The system also provides, for each peer computer systems, a storage profile, which is generated by reference to at least attributes relating to the hardware and software associated with each peer. The system further includes an agent module executing on each peer system to facilitate storage of data of a client peer from the plurality of peer computer systems on a service peer from the plurality of peer computer systems in response to a request for storing data from the client peer. In this embodiment, the service peer is selected by reference to the storage profile associated with the service peer and the storage profile associated with the client peer.

In yet another embodiment, the system further includes a governor node server, which provides for the selection of a service peer for a client peer making a request for storing client peer data. In this embodiment, the governor node transmitting instruction to an agent module associated with each of the client peer and the service peer to facilitate the storage of client peer data on the service peer.

### DETAILED DESCRIPTION

For the purposes of the discussion the following terms shall have the meaning as provided below:

Peer: a device on a network that can store and retrieve digital assets; a desktop computer attached to the internet; alternatively, a server, a handheld computer, or a phone.

User: the person who logically owns and manages a peer.

Client peer: a peer on a network that is requesting services, including backup storage.

Service peer: a peer on a network that is providing services, including providing storage for backup. Note that a peer can assume both the role of a client peer and a service peer, depending on the conducted operation.

Digital community: a collection of peers sharing a network and conforming to a set of rules dictating services performed on behalf of other peers.

Profile: facets of a peer, including amount of storage available, amount of storage required to be backed up, storage access time, storage availability, geographic location, operating system, and prevalent applications.

Citizenship: the reputation of a peer in a digital community.

Currency: the amount of storage a peer can reliably provide weighted by profile and citizenship Community rules: the set of rules governing peer services in a digital community.

Governor: a service that enforces community rules in a digital community.

Confederated model: a resource sharing network arrangement where peer systems enforce community rules in a distributed fashion.

Federated model: a resource sharing network arrangement where a centralized governor node participates in enforcement of community rules and other management tasks.

In the most basic example of a digital community, two user's systems, or peers, are both connected to the same network and agree to cooperate by sharing storage. For example, when both peers have free storage of 10 MB and each requires backup of 5 MB of storage, the two peers will each ‘lend’ 5 MB of backup storage to the community, and exchange digital assets requiring backup with one another. If peer A's device fails, peer A restores his digital assets from the copy residing on peer B's system.

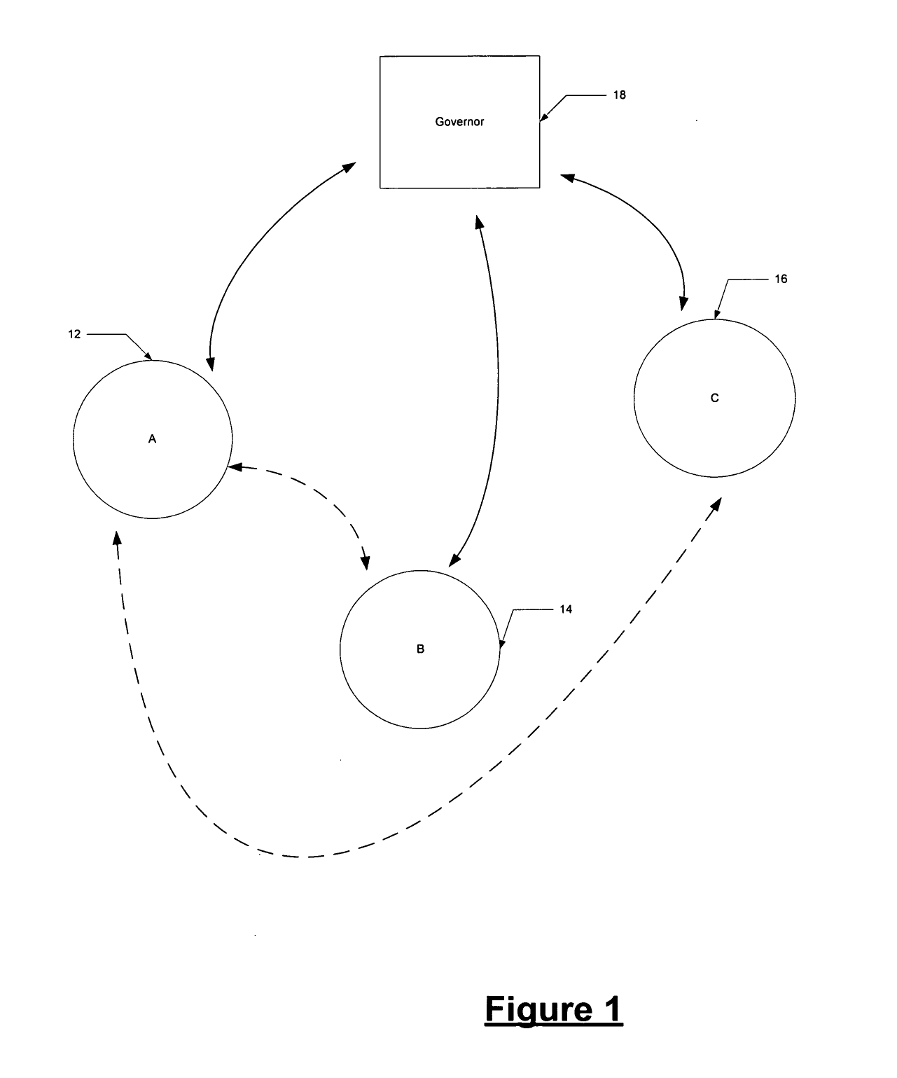

In a more complex example, a community of several devices conforms to a common set of rules in order to achieve the same goals of reliable storage and backup since the number of devices is too great to enforce by mutual agreement between members, the community rules managing the storage and backup is preferably automated in conformance with the profiles of the peers weighted by the behavior of those peers. Such rule enforcement and application is discussed below with reference to FIG. 1. FIG. 1 illustrates a storage community where three peers share storage. In the example of FIG. 1, the peers are managed by a management node 18, or governor node, that directs and controls storage of peer data on the community storage space (donated by peers). Such community rules dictate how peers will backup and retrieve storage from other peers and where such backup data is to be stored. For example, in one embodiment, the rules allow the community to answer the question whether a given peer should be granted backup storage on the community, how much backup storage to be granted, where the data should be stored, and what the requesting peer (client peer) must offer in exchange. The rules also control who may join the community, and who is dismissed from the community.

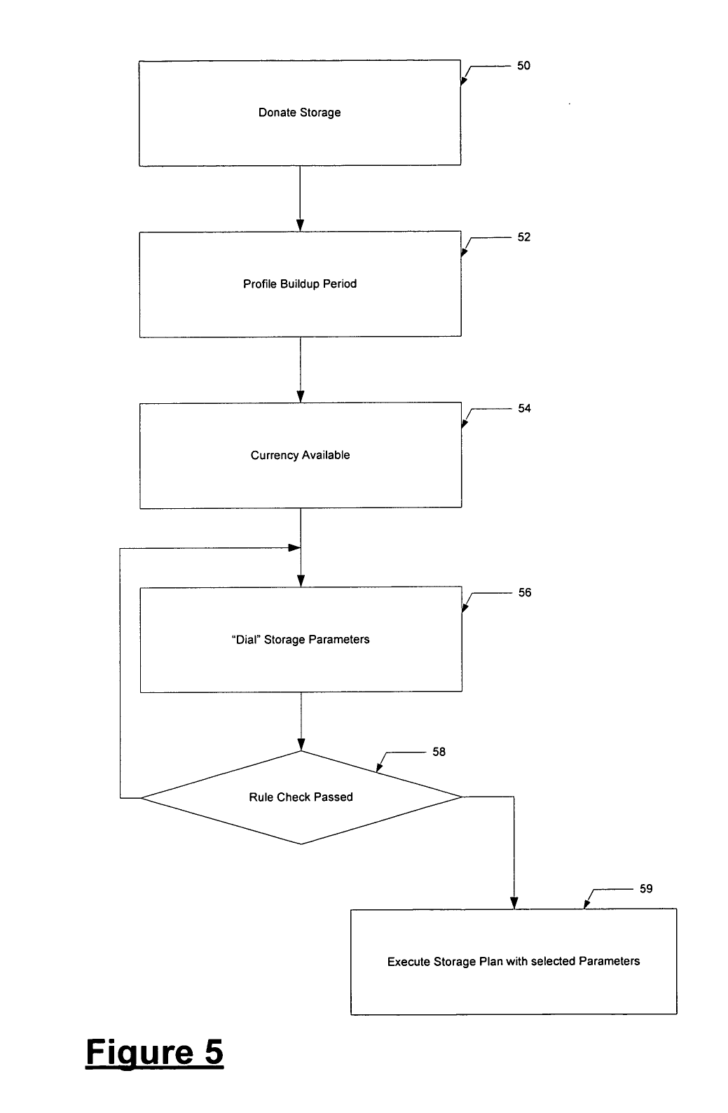

In the example of FIG. 1, each peer 12, 14, 16 communicates data to the management server 18. Such data includes initiation data (FIG. 5), recovery instructions, and security data. Each client peer 12, 14, 16 also stores backup data on storage media associated with a service peer. Specifically, client peer A 12 stores data on service peers B 14 and C 16, client peer B stores data on service peer A, and client peer C stores data on service peer A. In one instance of this example, peer A donates twice the data donated by peer B 14 and peer C 16 so as to allow peer A to increase data redundancy by storing the same data on two different service peers. In another instance of this example, peer A's storage requirements exceed those provided by either service peer B 14 or service peer C 16 alone and therefore peer A's data is divided between service peer B and service peer C.

Each peer is associated with a profile, which includes attributes such as the amount of free storage available, the amount of storage required for backup, frequency and size of backups, storage access time (which will primarily be a function of bandwidth and network performance on that peer), storage availability (for example, how often does that peer go to ‘sleep’), geographic location, hardware and software profile (including operating system and prevalent applications), and a network profile.

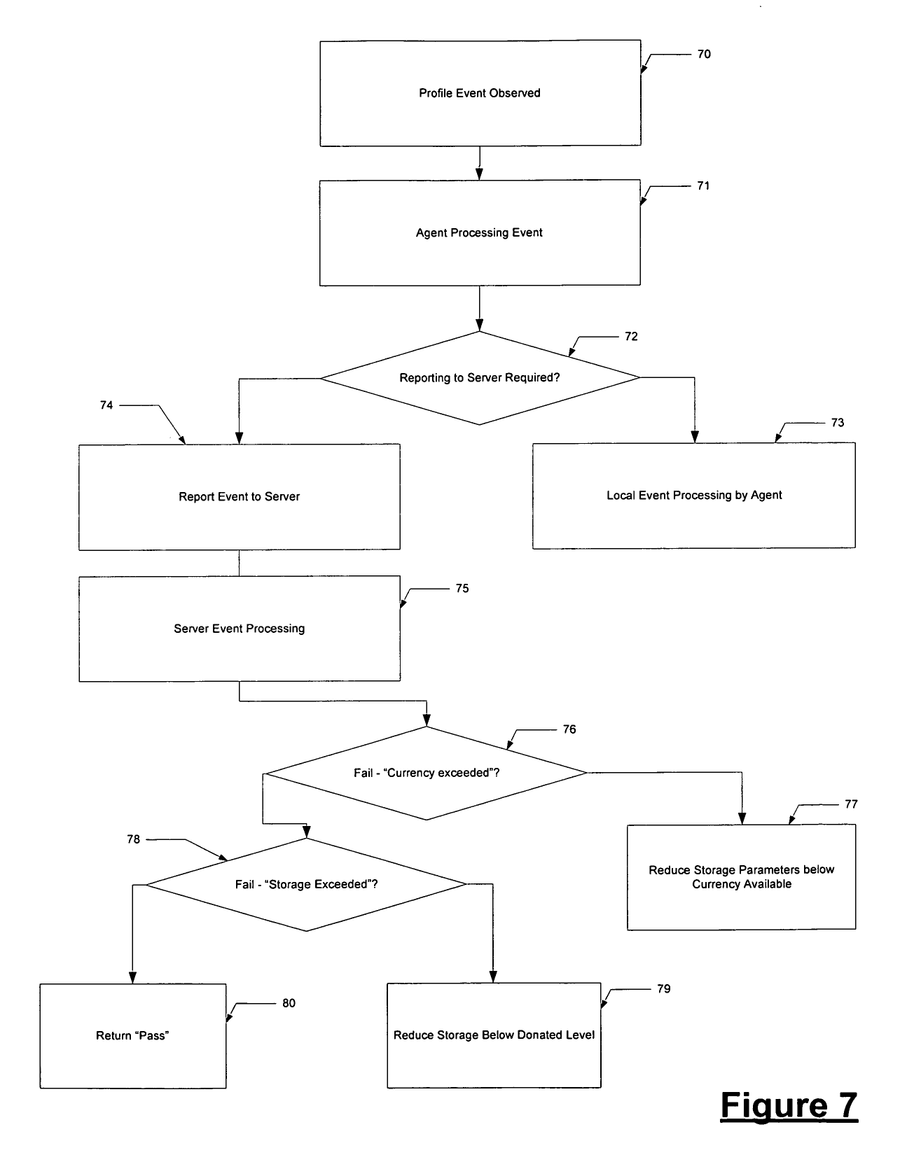

A reputation is assessed for each peer, which is characterized as the citizenship of that peer in the community. The citizenship of a peer is a function of their behavior and changes in profile over a period of time. For example, if a given peer reliably performs requested tasks of the community over a period of time, that peer's citizenship improves. If a given peer's profile changes (e.g. the device fails, new storage is added to the device, the operating system running on the device changes), the peer's citizenship is reassessed (FIG. 7).

A peer's currency is the amount of storage the peer offers to the digital community weighted by citizenship, which in turn is a function of profile and behavior over time. The currency of a peer will dictate, in turn, what the community will offer the peer in exchange for currency. In one embodiment, reciprocity forms the basis of community rules. If a given peer requires 10 MB of backup storage, for example, that peer will be required to offer 10 MB of backup storage for another peer on the network. If a given peer requests redundant storage, that peer will be required to offer the commensurate amount of storage to other members of the community. Good citizens in the community (e.g. peers who maintain reliable systems and whose reputations for performing community requests for storage and retrieval improve over time) will have their storage requests performed on peers with like citizenship. Similarly, peers with poor citizenship will have their backup storage on peers with like citizenship. In other words, the reliability a peer provides will shape the reliability of where its data is stored.

In one embodiment, the governor and enforcement of the set of rules is by a centralized approach, where a governor node is used. In another embodiment, in a decentralized mode, software running on each peer agrees to conform to and enforce the community's rules. In this decentralized mode, the governor may maintain automation via agents that enforce conformance to community rules, or alternatively, users themselves who adopt and voluntarily enforce such community rules. In the former case of decentralized governor, whereby the agents running on peers enforce community rules and update weighted profiles of peers, peer currencies and addresses are broadcast to a defined community using an open set of protocols. In the centralized mode, agent roles are preferably reduced to monitoring and controlling member peers.

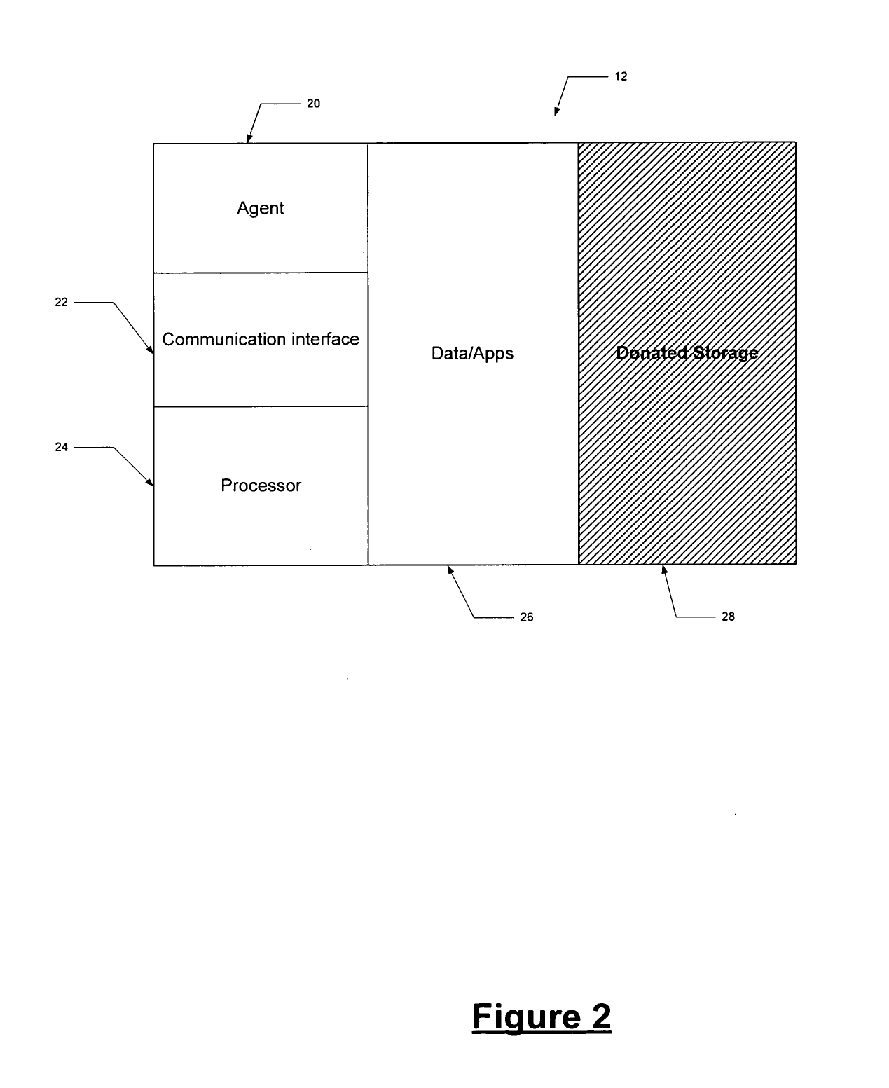

FIG. 2 illustrates logical elements of a peer system 12 in an embodiment of the invention. The peer system 12 includes an agent module 20, which contributes to the community interaction of the pier. The logical elements also include a communication interface 22, hardware (processor) 24, data (applications and related data) 26, and dedicated (donated) storage 28. The agent 20 is an application associated with a particular community storage implementation, which provides peer management services. In one embodiment, the agent secures the data that is stored on the associated peer such that it can only be retrieved and accessed by the owner-client peer. The agent also facilitates data backup services for the peer's own data (which it is a client peer with respect of). Finally, the agent 20 monitors the peer's citizenship to control and restrict how the peer's data is stored. As discussed above, the hardware 24, communication interface 22, and data 26 associated with the peer are some of the attributes monitored by the community as part of the peer profile and citizenship.

The communication interface 22 corresponds to the hardware and software by which the peer is coupled to a network which is employed to communicate with other peers of the storage community. The processor 24 is the hardware used to execute processes on the peer system. The data 26 includes applications executing on the peer processor and associated application data (digital assets). As may be appreciated, the combination of hardware 24, communication interface 22, and data 26, provides a system profile with a specific vulnerability as to data loss. Such vulnerability is referenced when determining which service peer is appropriate for an assessed client peer. As may be appreciated, it is advantageous to store client peer data on a service peer having different vulnerability profile so as to reduce the probability of a simultaneous system failure due to factors such as hardware failures, virus attack exploiting a software loophole, or network failures affecting specific network types protocols, or geographic regions.

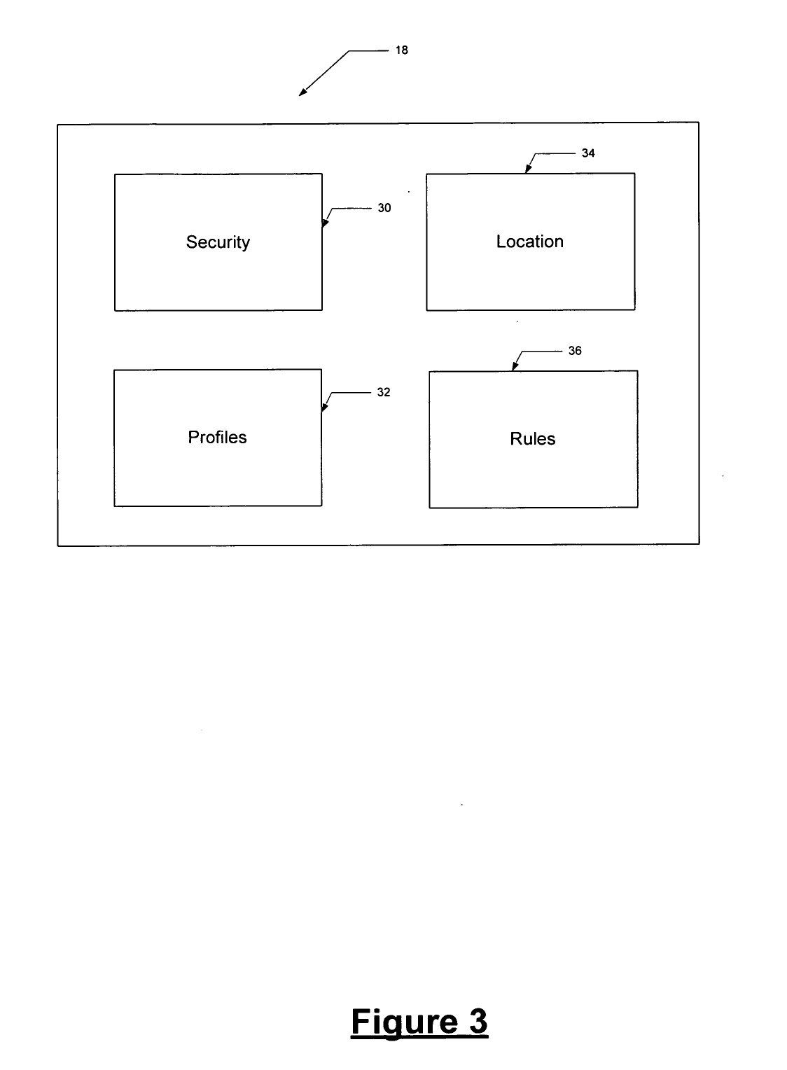

FIG. 3 illustrated the logical elements of a central governor node 18 in an implementation of the invention. The governor node 18 facilitates community arbitration and management services which include determining where peer data is stored, assessing and storing citizenship profiles for peers, applying community rules, and managing data security services such as data encryption, key storage, and data retrieval. The logical elements associated with the illustrated governor node 18 include a security module 30, a location module 34, a profiles module 32, and a rules module 36.

The security module 30 provides data security functionality for the secure storage of data as well as for the protection of data from unauthorized access. The location module 34 stores data relating to service peers which store client peer data. The location module 34 interacts with an agent 20 of a client peer during the data recovery stage, when the client peer's data is to be retrieved from its stored location. As may be appreciated, by employing a location module 34 in the governor node, the example community maintains secrecy as to where client data is stored, thereby preventing malicious access to the data or destruction of data when malicious programs target a client or service peer. In another embodiment, the governor node employs and updates this location information to transparently migrate or duplicate data between service peers.

As discussed above with reference to the peer system logical elements, in some implementation of the invention, diverse communities are desirable and offer a higher degree of reliable backup and storage. For example, in such a community where there is substantial geographical diversity, those systems in a geographic region adversely affected by a natural disaster could rely on systems in other geographic regions. Similarly, if a particular computer virus successfully destroys certain software programs or systems, a diversity of software programs (e.g. operating systems, email clients, applications, etc.) would likely reduce the impact of the virus on the overall community, and hence enhance the probability of the community recovering data. Hence, the location module 34 of the governor node diversifies storage by reference to such factors so as to increase storage reliability for client peers.

The profiles module 32 stores peer profile data by reference to data attributes of peer citizenship. The profiles module 32 further updates peer profiles in response to profile events (FIG. 7) or as a result of an explicit periodic query by the community. In one embodiment such query is used to ensure that the agent module has not been tampered with and has manipulated the data. In this embodiment, the community transmits a request to the agent for processing a known function with the stored data as input (e.g., hash function). Hence, the community is able to verify data integrity by application of such periodic queries. In one embodiment, the governor node measures profiles and citizenship by directly communication with a peer node such as by “pinging” the node to measure connectivity.

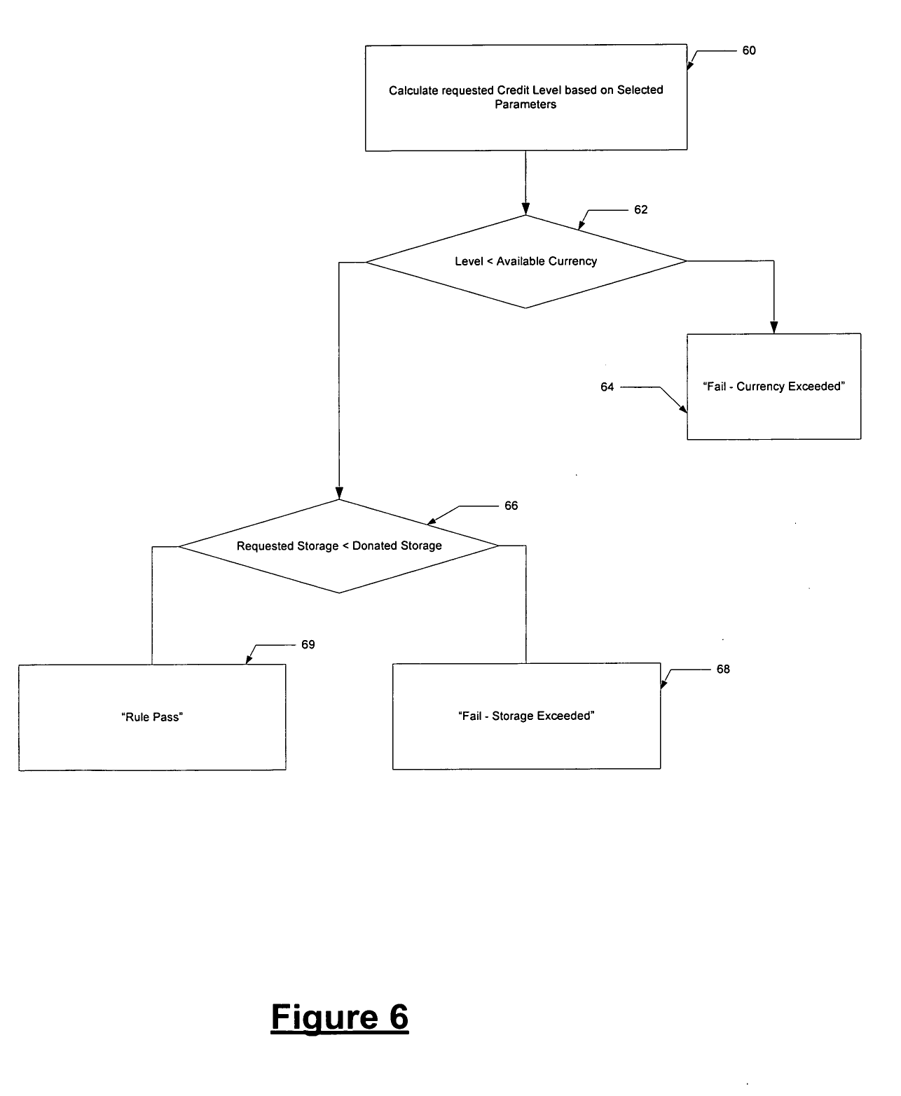

The profiles module 32 is employed by the location module to identify a proper service peer for a client peer requesting storage or when there is a change in peer currency (due to citizenship event) which requires moving client peer data to another service peer with a different service quality (currency requirement). The rules module 36 applies community rules relating to profile events, storage requests, and retrieval requests. The rules module 36 processes rules in response to requests from the location module and from the profiles module. The operation of the rules module 36 when processing an example rule is discussed below with reference to FIG. 6.

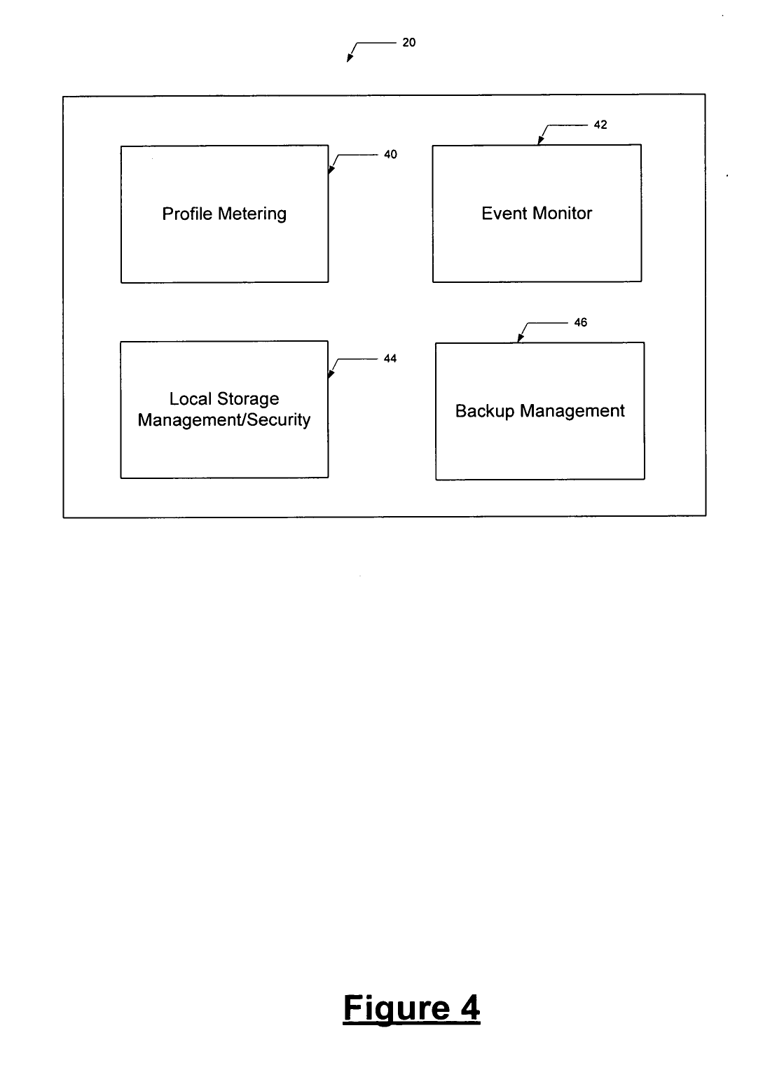

FIG. 4 illustrates logical elements of an agent module 20 in a storage community implementation of the invention which is illustrated in FIG. 1. The agent module 20 includes a profile element 40, an event monitoring element 42, a local storage element 44, and a backup management element 46. The local storage element 44 manages data protection for data stored by the peer as a service peer to prevent unauthorized access to, or copying of, stored data. The local storage element 44 also provides functions for facilitating storage of client peer data in accordance with encryption and location instructions from a governor node or an agent module 20 in a confederated implementation. Furthermore, when the data is required by the client peer, the local storage element facilitates the retrieval of data and transmission to the client peer without intervention from, or disruption of, the service peer system. The profile element 40 provides functions for monitoring the local peer system so as to asses citizenship. As may be appreciated, various methods may be employed by the profile element 40 to assess citizenship of the corresponding peer system. For example, in one method, a citizenship module resides alongside the agent (in the confederated model) or on the governor (in the federated model). The citizenship module initially establishes citizenship as a function of the currently proposed and assessed profile. The citizenship module then tracks and records behavior over time, e.g. changes in profile. The citizenship is then updated with any change in profile. Recent changes to profiles have a higher weighting than distant changes. For example, if a peer profile offers 10 MB of storage, 24 hours/7 days up time, and 1 MB/sec transfer time, an initial citizenship is granted reflective of that profile. If over time the citizenship module notices that up time is reduced to 20 hours/7 days, the citizenship score is reduced. If over time there is a disruption, for example the transfer time is only 500 KB/sec, the citizenship is reassessed. (FIG. 7) The citizenship module also utilizes a behavior algorithm that weights different aspects of profile changes over time. In another embodiment, different profile attributes are also weighted differently. For example, in one embodiment, storage space and uptime are weighted higher than transfer performance.

The event monitor 42 facilitates responding to events of the peer system which may affect its currency (citizenship or profile) or affect the stored data. For example, if the local peer installs software which is known to be vulnerable to viruses, a profile event is observed and processed (FIG. 7). The event monitor further responds to events affecting the stored data such as the user overwriting stored data or the storage media having malfunctioned or replaced.

The backup management module 46 provides functions for managing storage of the local peer data on a service peer. Such functions include communicating with a governor node (or another agent directly in the confederated model) to acquire a service peer and controlling the transmission of data to be stored on the assigned peer in accordance with scheduling and security parameters from the community.

In one embodiment, peer data confidentiality is protected by utilized encryption keys. There are three types of keys contemplated: a simple pin code, a physical hardware key, and keys generated and stored automatically by a governing service. In all three instances, the keys will not reside on the peers in the network, and will either be retained by the user (owner of the peer) or the governing service.

As discussed above, FIG. 1 illustrates a federated digital community implementation of the present invention. The illustrated embodiment includes a collection of multiple peers, and a centralized governor 18. The centralized governor 18 preferably enforces community rules, establishes and maintains citizenship of each peer in the community, performs data addressing functions, manages encryption keys. FIG. 5 illustrates the enrollment process for a peer in the illustrated community of FIG. 1. In one embodiment, the process of a peer petitioning a governor to join a community could be as simple as a user logging into a web site and presenting their address and profile. The peer first donates some storage to the community (Step 50). If acceptable to both parties (the governing service which administers this enrollment web site and the petitioning peer), the governor will distribute agent software to the peer. The peer profile is then observed by the agent during a profile buildup period (Step 52). At the conclusion of the profile buildup period, the peer is allocated currency in accordance with the donated storage and observed profile (Step 54). The peer then requests certain storage parameters for a desired storage Quality of Service (“QoS”) level. In one embodiment, the user select a level for each attribute of the desired storage node by “dialing” a desired level for each attribute (Step 56). Such “dialed” attributes include both profile related attributes as well as citizenship related attributes, such as “Uptime/Downtime.” The community (agent or governor node) verifies that the “dialed” parameters comply with community rules (Step 58) (FIG. 6). If the requested parameters are within the rules, the community determined a storage plan for the peer data and facilitates execution of the storage plan by employing the community storage and any required governor node storage (Step 59).

FIG. 6 illustrates the operation of a rule verification module when confirming storage parameter selections by a client peer. The module determines the currency or credit level associated with the requested parameters (Step 60). In one embodiment such credit level is proportional to the requested storage, quality of storage, and requested behavior. The module then compares the requested credit level to the currency available to the client peer (Step 62). If the currency is lower than the requested credit level, the module provides a “fail—currency exceeded” message in response to the rule verification request (Step 64). If the currency is greater than the requested credit level, the module compares the requested storage to the storage donated by the peer (Step 66). If the donated storage is less than the requested storage, the module returns a message “fail—storage exceeded” in response to the rule verification request (Step 68). If the donated storage is greater than the requested storage, the module return a “rule pass” message (Step 69).

In one embodiment, agents running on peers are governed by the centralized governor. The agents store and retrieve data when requested by the governor. FIG. 7 illustrates the operation of the agent on a peer when detecting a reputation related event. The agent observes a profile event (step 70). The agent processes the event (Step 71) and then determines if reporting to the governor node is required (Step 72). As may be appreciated, not every event should be reported to the governor node. Events that can be resolved locally by the agent module are processed by the module (Step 73). Events that need governor node attention, such as loss of stored data, should be reported to the governor node (Step 74). If an event needs to be reported to the governor node, event processing at the governor node takes over (Step 75). If processing the profile event results in the peer currency falling below the currency required for storing its data at the current storage peer location (Step 76), the peer requested storage parameters should be “dialed” down to reduce currency use (Step 77). In one embodiment, the governor node automatically reduces the storage parameters so as to fall within the available currency. In another embodiment, the governor node interacts with the user to select reduced storage parameters which are within the available currency. Preferably such correction in storage currency is only performed on a limited periodic basis, so as to not overload the community and disrupt storage transaction. After new parameters are selected, the governor node initiates data transfers to implement the new peer relationships. In one embodiment, such data transfers employ local storage at the governor node as temporary buffer storage.

If the new peer profile does not pass the rules due to exceeded storage (Step 78), the governor node adjusts the storage available to the peer below the donated storage level (Step 79). The user is then contact by the community to select data for storage in accordance with the new storage level. If storage is not exceeded, the rule processing returns a “pass” indication (step 80). After data is selected for storage, the data is stored by the community by selecting an appropriate peer and moving data between the peers. As may be appreciated, the data is preferably compressed prior to storing on the service peer.

In one embodiment, the user further specifies an importance indication for identifiable data collections or specific data items (e.g., documents, photos, specific files, etc.). The community employs the importance designation to prioritize allocation of resources to the peer so as to provide a higher QoS for the more important data or so as to effectively employ newly excess community resources. In another embodiment, the agent module automatically prioritizes data by reference to factors such as access frequency and predetermined ranking by data type. In one embodiment, the agent module associated with the client system manages the allocation of resources to the client peer data by reference to the importance indication from the user. As may be appreciated, such importance indication is further employed when resources are removed from the community to determine which client data should be preserved and which should be discarded. In another embodiment, where excess resources are available, the community automatically increases the QoS with respect to certain peer data by allocating more than one resource to the peer data.

In yet another embodiment, a pay-to-store service is made available to client peers. In this embodiment, a client peer purchases storage credits which are then added to the client peer currency. The currency is then used to acquire storage resources of the community, which now include the purchased storage. As may be appreciated, the client peer data is not always stored on the pay-service storage server since such server may not always be the optimal location for storing the client data (e.g., same ISP, same city). Hence, the pay-to-store option is sometimes employed as a pay-to-donate option where payment is used to acquire storage that is then donated to the community in the name of the purchasing client peer.

As may be appreciated, in some community implementations, a peer may be banished from the community by the governor, at which point, any storage offered by that peer for backup by other members of the community is transferred to another member of the community. Examples of community rules for enforced banishment include cases where a peer does not conform to the community rule, a peer seeks to harm the community, a peer's citizenship degrades to the point where that peer cannot provide any useful services/storage to the community, etc.

In another embodiment, the storage community is facilitated as a confederated digital community where agents running on peers enforce community rules. In this embodiment there is no centralized governing service. Encryption keys are preferably maintained by users themselves, advantageously in hardware modules. Agents also store addressing information on a hardware module to prevent loss of addressing data on system failure. In such implementation a peer is invited to join community be an existing member. A client peer will broadcast their profile over a defined broadcast band for that network. To obtain storage, a client peer will broadcast a storage requests over defined broadcast band to members of their community. An available service peer will accept the broadcast and perform the requested service, at which point the client peer no longer broadcasts the request. Citizenship is gauged by self measuring agents and is stored on each peer. Agent modules on peers update the citizenship other peers based on events. Importantly, in a confederated digital community, the broadcast and distribution of peer profiles and addresses must be maintained only by members of the community. As such, this content is distributed in an encrypted form or channel to other peers, and peers may only join these communities by invitation from a member of the community. In some circumstances, the community rules may dictate that a majority of peers in the community must accept the petition for a new member (peer), etc.

In another embodiment, a storage community of the invention is implemented as a non-federated digital storage community. In this implementation, community rules are enforced by users and not agents or governing service. The operation of the community is the same as in the confederated case except responsibility of agent software running on the peer is delegated to the actual user.

1. A resource management system for increasing the throughput of resources of peer system, comprising:
a plurality of peer computer systems, each peer computer system including computer system hardware, communication interface, applications, and data;
a contributed resource list associated with each of said peer computer systems, each list defining the contributed resources of the associated peer system;
a resource profile associated with each of said peer computer systems, the resource profile for each peer generated by reference to attributes of contributed resources of each peer; and
an agent module executing on each said peer system, the agent module facilitating utilization of contributed resources by a client peer from said plurality of peer computer systems in response to a request for resource utilization from said client peer, the resource selected by reference to its resource profile and the resource profile of resources in the contributed resource list of the client peer.

2. The system of claim 1, further comprising a governor node server, the governor node server providing for the selection of a service peer for a client peer making a request for a resource, the governor node transmitting instructions to an agent module associated with each of the client peer and the service peer to facilitate the utilization of the resource.

3. The system of claim 2, wherein the governance node enforces community rules, the community rules referring to user behavior and resource profile corresponding to each peer system.

4. The system of claim 1, wherein each agent module further monitors utilization of each contributed resource and further refers to such utilization monitoring when facilitating utilization of the contributed resource by a client peer.

5. The system of claim 1, wherein each agent module further determined a currency level for the associated peer by reference to the peer's contributed resources profile and by reference to periodically monitored peer system user behavior.

6. The system of claim 5, wherein said client agent module select a contributed resource from said plurality of contributed resources by reference to the currency level for the requesting client peer and the currency level of contributed resources available on said plurality of peer computer systems.

7. The system of claim 6, wherein said request for resource utilization by a client peer includes parameters of a desired resource, said parameters corresponding to a currency level of said contributed resource.

8. A method for allocating network resources, the resources shared between a plurality of peer systems, each resource donated and maintained by a peer system:
monitoring predetermined attributes associated with a donated resource associated with a first peer system and at least a second peer system;
monitoring maintenance of the resource by the first peer system and at least said second peer system; and
allocating a resource of the second peer system to the first peer system, in response to a request for a resource by the first peer system, by reference to said monitoring of attributes for the donated resource associated with the first peer system, the monitored maintenance by the first peer system, the monitored attributes of the allocated resource and the monitored maintenance by the peer associated with the allocated resource.

9. The method of claim 8, further comprising monitoring usage of at least one of said resources and allocating said resource by additionally referring to said monitoring of usage.

10. The method of claim 8, whereby said allocating ensures that at least one attribute an allocated resource does not exceed a corresponding level of the same attribute of the donated resource.

11. The method of claim 9, further comprising verifying that all allocating to all peers ensures that the same attribute of an allocated resource does not exceed a corresponding level of the same attribute of the donated resource.

12. The method of claim 8, further comprising:
detecting a change in a donated resource attribute of the first peer; and
allocating a new resource to the first peer system in response to said detecting by reference to said monitoring of changed attributes for the donated resource associated with the first peer, the monitored maintenance by the first peer system, the monitored attributes of the allocated resource and the monitored maintenance by the peer associated with the allocated resource.

13. The method of claim 8, further comprising:
detecting a change in maintenance by the first peer system; and
allocating a new resource to the first peer system in response to said detecting by reference to said monitoring of attributes for the donated resource associated with the first peer, the monitored maintenance change by the first peer system, the monitored attributes of the allocated resource and the monitored maintenance by the peer associated with the allocated resource.

14. The method of claim 8, further comprising:
Periodically monitoring the attributes of the donated resource and the maintenance of the resource by the first peer system; and
Allocating a new resource to the first peer system in response to a change in attributes or in maintenance which exceeds a threshold.

15. The method of claim 8, wherein at least one network resource is communication bandwidth available to a peer system.

16. The method of claim 8, wherein at least one network resource is software resident on a service peer.

17. The method of claim 16, wherein said software is associated with limited use rights and further comprising ensuring that said use rights are not exceeded by allocating use of said software to a client peer.

18. The method of claim 8, wherein at least one network resource is a digital right to exploit data stored on at least one peer from said plurality of peer systems.

19. The method of claim 8, wherein all network resources are storage space on peer systems of said plurality of peer systems.

20. The method of claim 18, further comprising modifying the storage location of said data by reference to the client peer exploiting said data.
